(19) United States
(12) Patent Application Publication
(10) Pub. No.: US 2025/0298178 A1
(43) Pub. Date: Sep. 25, 2025

(54) METHOD FOR MANUFACTURING A WIRE-GRID POLARIZER

(71) Applicant: AimCore Technology Co., Ltd., Hsinchu (TW)

(72) Inventor: Wein-Kuen Hwang, Fuxing Township (TW)

(73) Assignee: AimCore Technology Co., Ltd., Hsinchu (TW)

(21) Appl. No.: 18/614,892

(22) Filed: Mar. 25, 2024

(51) Int. Cl. G02B 5/30

(52) U.S. Cl. CPC G02B 5/3058; G02B 5/3041

(57) ABSTRACT

In a method for manufacturing a wire-grid polarizer, a thin metal layer is formed on a transparent substrate. Then, an electroforming process is performed on the thin metal layer to form metal wires. Finally, the thin metal layer exposed among the metal wires is converted into a transparent dielectric layer using a chemical reaction, thereby forming the wire-grid polarizer.

### BACKGROUND OF THE INVENTION

### Field of the Invention

The present invention relates to a wire-grid polarizer (WGP), particularly to a method for manufacturing a wire-grid polarizer with low cost and good transmittance and extinction ratio.

### Description of the Related Art

FIG. 1 shows a traditional metal wire-grid polarizer (WGP) 10 to explain the operating principle of the metal wire-grid polarizer 10. FIG. 2 shows a cross-sectional view of the metal wire-grid polarizer 10 of FIG. 1. The metal wire-grid polarizer 10 includes a transparent substrate 12 and a plurality of metal wires 14. The metal wires 14 are arranged in parallel on the transparent substrate 12 to form a metal wire grid. Assume that the incident light Li is un-polarized light. The incident light Li includes P-polarized light Ip and S-polarized light Is, where the intensity of the P-polarized light Ip is equal to that of the S-polarized light Is. The electric field of the P-polarized light Ip is perpendicular to the metal wires 14 and the electric field of the S-polarized light Is is parallel to the metal wires 14. When the incident light Li irradiates the metal wire-grid polarizer 10, the S-polarized light Is interacts with the metal wires 14 to form an electric dipole, so that most of the S-polarized light Is are reflected by the metal wire-grid polarizer 10 to form S-polarized light Rs as reflected light Lr. Only a small part of the S-polarized light Is passes through the metal wire-grid polarizer 10 to form S-polarized light Ts as transmitting light Lt. Since the electric field of P-polarized light Ip is perpendicular to the metal wires 14, the electric field of P-polarized light Ip does not interact with the metal wires 14 to generate an electric dipole. The P-polarized light Ip almost completely passes through the metal wire-grid polarizer 10. That is to say, the P-polarized light Ip of the incident light Li is almost identical to the P-polarized light Tp of the transmitting light Lt

The quality of the metal wire-grid polarizer 10 can be determined by the transmittance Tr and the extinction ratio Er of the metal wire-grid polarizer 10, where Tr=Tp/Ip and Er=Tp/Ts. The greater the transmittance Tr and the extinction ratio Er, the better the efficiency of the metal wire-grid polarizer 10. In general, when the metal wire 14 has a narrower line width W and a higher height H, the transmittance Tr and the extinction ratio Er are greater.

In order to obtain good transmittance Tr and extinction ratio Er, the metal wire-grid polarizer 10 is manufactured using fabrication processes such as nanoimprint lithography and dry etching. However, the production cost of nanoimprint lithography and dry etching is relatively high, resulting in the too high unit price of the metal wire-grid polarizer 10. As a result, it is difficult to promote the application scope of the metal wire-grid polarizer 10 and expand the scale of the application market of the metal wire-grid polarizer 10.

FIG. 3 shows a cross-sectional view of a metal wire-grid polarizer 20 manufactured using an electroforming process. The metal wire-grid polarizer 20 of FIG. 3 includes a transparent substrate 22, a transparent conduction layer 24, and metal wires 26. Since the metal wires 26 cannot be directly electroformed on the transparent substrate 22, the transparent conduction layer 24 must be firstly covered on the transparent substrate 22 and then the metal wires 26 can be formed on the transparent conduction layer 24 using the electroforming process. The metal wires 26 are arranged in parallel on the transparent conduction layer 24 to form a metal wire grid. The cost of the electroforming process is low, approximately 1/10 of processes such as nanoimprint lithography and dry etching. In order to obtain good electroforming characteristics, it is necessary to increase the thickness of the transparent conduction layer 24 to reduce the resistance of the transparent conduction layer 24, thereby increasing the electroforming rate and improving the electroforming uniformity. However, the transparent conduction layer 24 has optical absorptivity and conductivity. Therefore, as the thickness of the transparent conductive layer 24 increases, the transmittance Tr and the extinction ratio Er of the metal wire-grid polarizer 20 will decrease.

Therefore, a method for manufacturing a metal wire-grid polarizer with low cost and good transmittance and extinction ratio is desired.

### SUMMARY OF THE INVENTION

The objective of the present invention provides a method for manufacturing a wire-grid polarizer with low cost and good transmittance and extinction ratio.

According to an embodiment of the present invention, a method for manufacturing a wire-grid polarizer includes: forming a thin metal layer on a transparent substrate; performing a electroforming process on the thin metal layer to form metal wires that are arranged in parallel, wherein a part of the thin metal layer is exposed among the metal wires; and performing a chemical reaction on the part of the thin metal layer to convert the part of the thin metal layer into a transparent dielectric layer, thereby forming the wire-grid polarizer. Since the metal wires of the present invention are formed by an electroforming process, the cost of the metal wire-grid polarizer of the present invention is low. Besides, the thin metal layer among the metal wires will be converted into a transparent dielectric layer using a chemical reaction. Therefore, the metal wire-grid polarizer of the present invention has good transmittance and extinction ratio.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram showing a conventional metal wire-grid polarizer;

FIG. 2 is a cross-sectional view of a metal wire-grid polarizer of FIG. 1;

FIG. 3 is a cross-sectional view of a metal wire-grid polarizer manufactured using an electroforming process;

FIG. 4 is a flowchart of a method for manufacturing a wire-grid polarizer according to a first embodiment of the present invention;

FIGS. 5-10 are schematic diagrams showing the steps of a method for manufacturing a wire-grid polarizer of FIG. 4;

FIG. 11 is a schematic diagram showing a thin metal layer whose activity greater than the activity of a metal wire according to an embodiment of the present invention;

FIG. 12 is a schematic diagram showing a metal wire composed of multiple layers of different materials according to an embodiment of the present invention;

FIG. 13 is a flowchart of a method for manufacturing a wire-grid polarizer according to a second embodiment of the present invention; and

FIGS. 14-19 are schematic diagrams showing the steps of a method for manufacturing a wire-grid polarizer of FIG. 13.

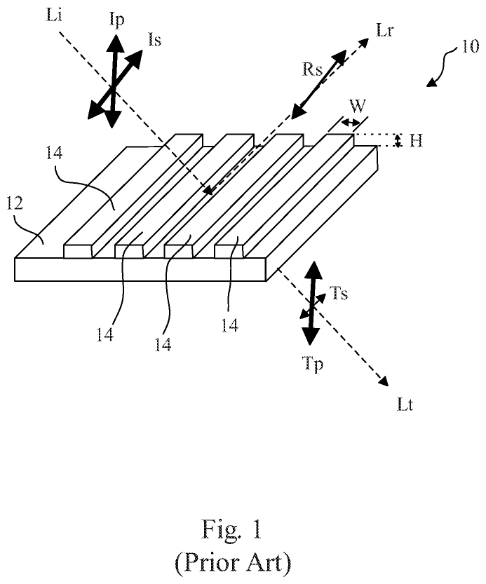

### DETAILED DESCRIPTION OF THE INVENTION

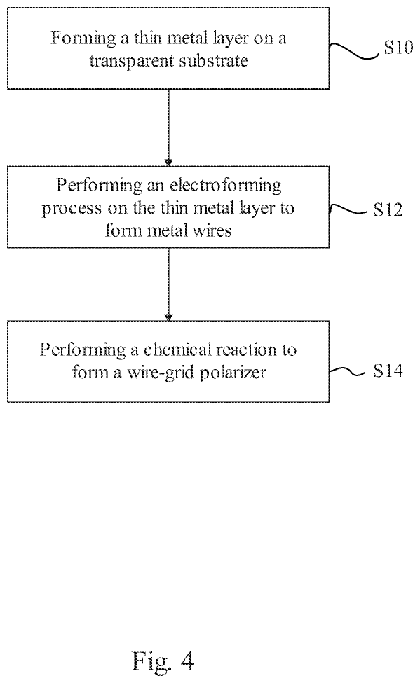

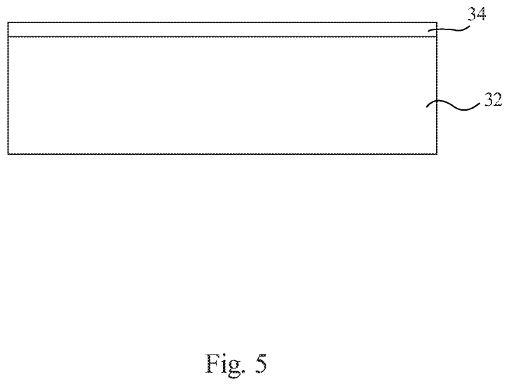

FIG. 4 shows a first embodiment of the method for manufacturing a metal wire-grid polarizer of the present invention. FIGS. 5-10 are schematic diagrams showing the steps of the method for manufacturing the wire-grid polarizer of FIG. 4. As shown in Step S10 of FIG. 4 and FIG. 5, the method for manufacturing a metal wire-grid polarizer 30 of the present invention includes forming a thin metal layer 34 on a transparent substrate 32, where the material of the thin metal layer 34 can be, but not limited to, aluminum, nickel, copper, or iron. One of the functions of the thin metal layer 34 is to form metal wires using an electroforming process in next Step S12.

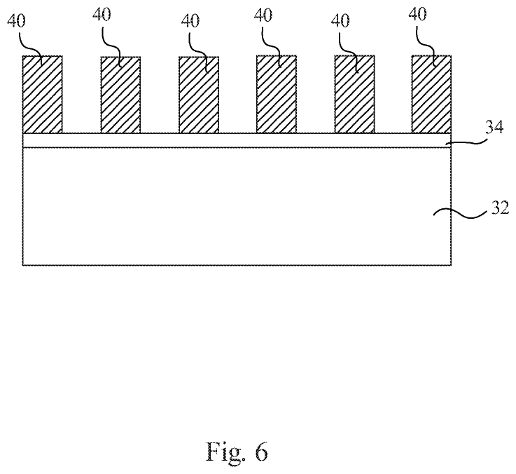

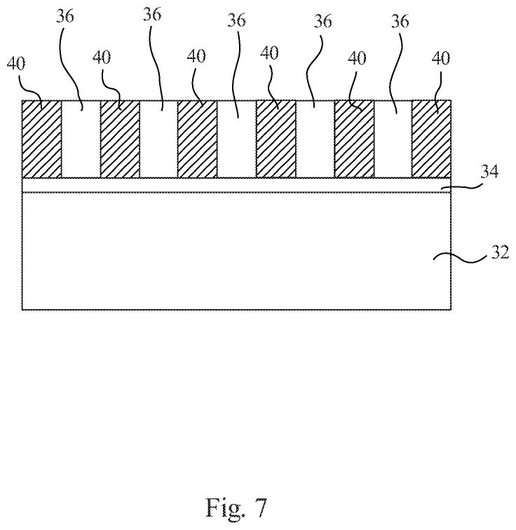

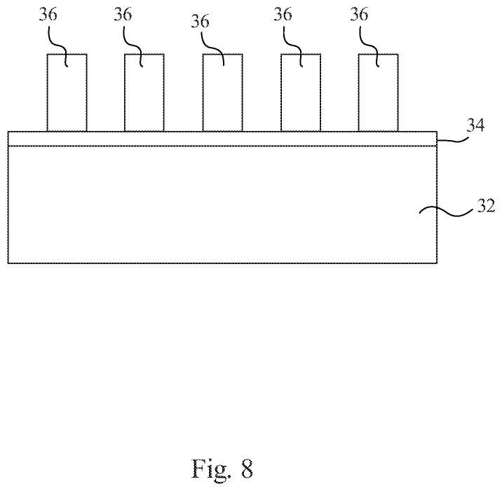

After forming the thin metal layer 34, Step S12 is performed. In Step S12, a photoresist pattern 40 is firstly formed on the thin metal layer 34, as shown in FIG. 6. The photoresist pattern 40 may be a hard photoresist or a soft photoresist. The photoresist pattern 40 may be formed using, but not limited to, an imprint resist. After the photoresist pattern 40 is formed, an electroforming process is then performed on the area of the thin metal layer 34 not covered by the photoresist pattern 40 to form metal wires 36 arranged in parallel, as shown in FIG. 7. The materials of the thin metal layer 34 and the metal wires 36 may be identical or different. After the metal wires 36 are formed, the photoresist pattern 40 is removed, as shown in FIG. 8. In FIG. 8, the cross-sectional shape of the metal wire 36 is a rectangle, but the present invention is not limited thereto. The shape of the metal wire 36 can be various regular or irregular shapes. For example, the cross-sectional shape of the metal wire 36 may alternatively be a trapezoid with a narrow top and a wide bottom or with a narrow bottom and a wide top.

After forming the metal wires 36 and removing the photoresist pattern, Step S14 is performed. In Step S14, a chemical reaction is performed on a part of the thin metal layer 34 exposed between the metal wires 36 to convert the part into a transparent dielectric layer 38 so that incident light can pass through the transparent dielectric layer 38. The chemical reaction of Step S14 includes, but is not limited to, oxidation, nitridation, fluorination, or sulfidation. After the chemical reaction of Step S14, the thin metal layer 34 and the metal wires 36 form a metal wire grid to form the metal wire-grid polarizer 30 of the present invention.

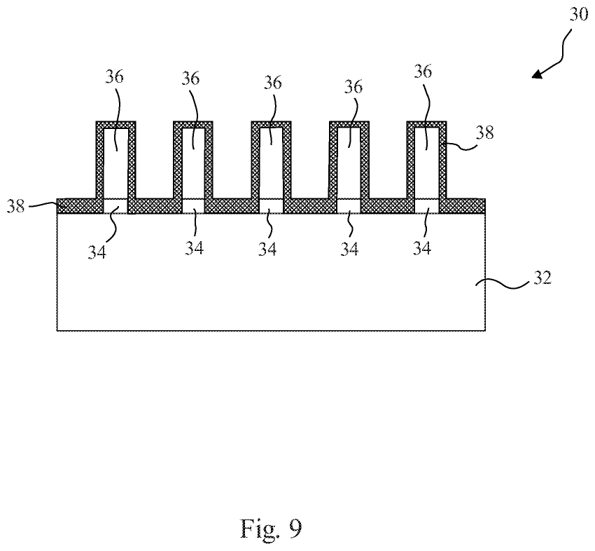

In one embodiment, if the thin metal layer 34 and the metal wires 36 include the identical material or if the thin metal layer 34 and the metal wires 36 include different materials that can be used for chemical reactions, the thin metal layer 34 exposed among the metal wires 36 and the surface layers of the metal wires 36 will be converted into a transparent dielectric layer 38 in the chemical reaction of Step S14, as shown in FIG. 9.

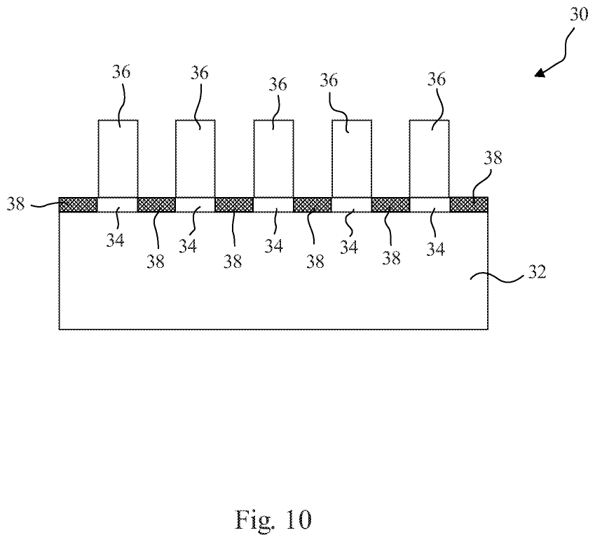

In one embodiment, if the thin metal layer 34 and the metal wires 36 include different materials and the metal wires 36 do not be used for chemical reactions, only the thin metal layer 34 exposed among the metal wires 36 is converted into a transparent dielectric layer 38 in the chemical reaction of Step S14, as shown in FIG. 10.

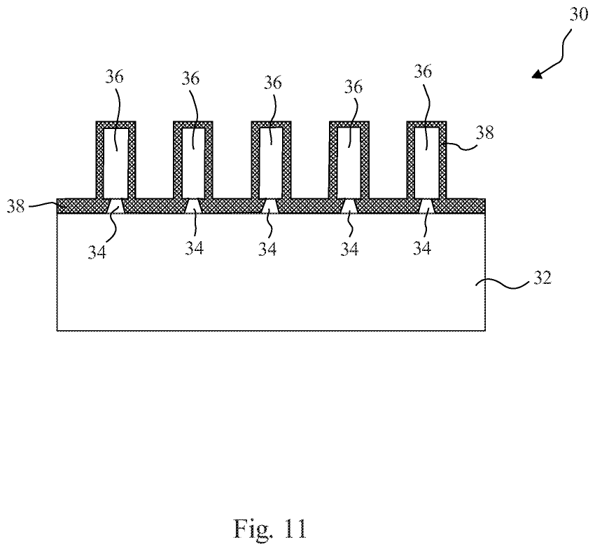

In one embodiment, when the thin metal layer 34 and the metal wires 36 include different materials and the activity of the thin metal layer 34 is greater than that of the metal wire 36, the thin metal layer 34 has more parts converted into the dielectric layer 38 after the chemical reaction of Step S14. As a result, the metal wire grid will have a shape that is wide at the top and narrow at the bottom, as shown in FIG. 11.

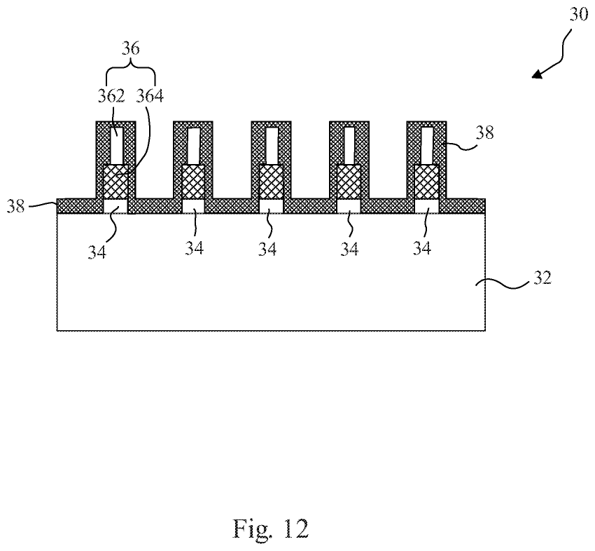

In one embodiment, the metal wire 36 may be composed of multiple layers of different materials. As shown in FIG. 12, each metal wire 36 includes a first metal layer 362 and a second metal layer 364. When the activity of the first metal layer 362 is greater than that of the second metal layer 364, more parts of the first metal layer 362 are converted into the dielectric layer 38 after the chemical reaction of Step S14. As a result, the shape of the metal wire 36 will be narrow at the top and wide at the bottom, as shown in FIG. 12. On the contrary, when the activity of the first metal layer 362 is less than that of the second metal layer 364, more parts of the second metal layer 364 are converted into the dielectric layer 38 after the chemical reaction of Step S14. As a result, the shape of the metal wire 36 will be wide at the top and narrow at the bottom.

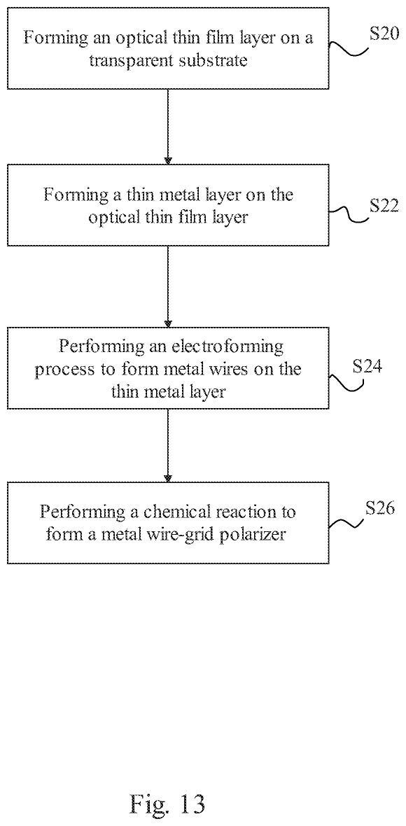

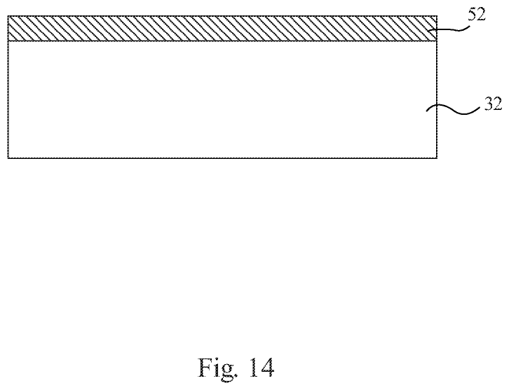

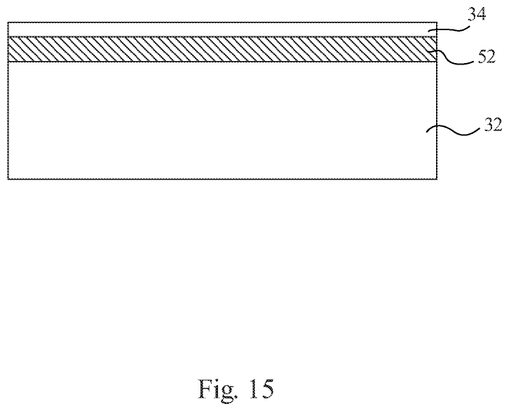

FIG. 13 is a flowchart of a method for manufacturing a wire-grid polarizer according to a second embodiment of the present invention. FIGS. 14-19 are schematic diagrams showing the steps of a method for manufacturing a wire-grid polarizer of FIG. 13. As shown in Step S20 of FIG. 13 and FIG. 14, the method for manufacturing a wire-grid polarizer 50 of the present invention includes forming an optical film layer 52 on a transparent substrate 32, where the optical film layer 52 can be, but not limited to, an anti-reflective layer. After the optical film layer 52 is formed, Step S22 is performed. A thin metal layer 34 is formed on the optical film layer 52, as shown in FIG. 15.

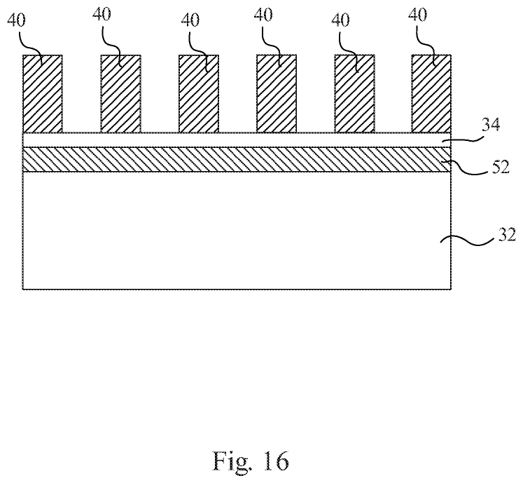

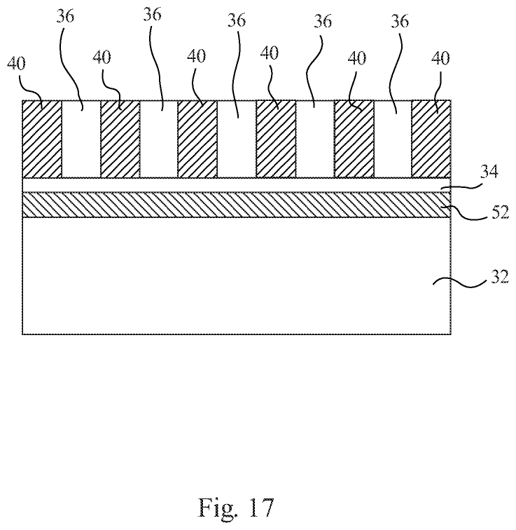

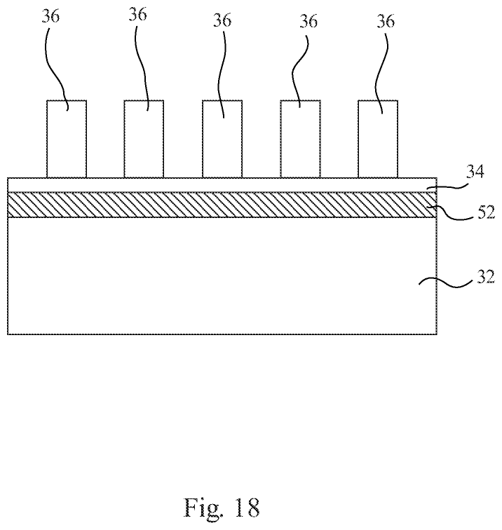

After forming the thin metal layer 34, Step S24 is performed. In Step S24, a photoresist pattern 40 is firstly formed on the thin metal layer 34, as shown in FIG. 16. After the photoresist pattern 40 is formed, an electroforming process is then performed on the area of the thin metal layer 34 not covered by the photoresist pattern 40 to form metal wires 36 arranged in parallel, as shown in FIG. 17. The materials of the thin metal layer 34 and the metal wires 36 may be identical or different. After the metal wires 36 are formed, the photoresist pattern 40 is removed, as shown in FIG. 18.

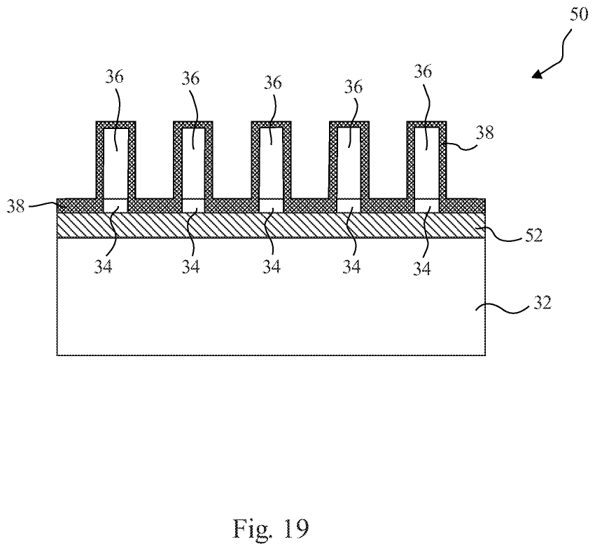

After forming the metal wires 36 and removing the photoresist pattern, Step S26 is performed. In Step S26, a chemical reaction is performed on a part of the thin metal layer 34 exposed among the metal wires 36 to convert the part into a transparent dielectric layer 38 so that incident light can pass through the transparent dielectric layer 38. If the thin metal layer 34 and the metal wires 36 include the identical material or if the thin metal layer 34 and the metal wires 36 include different materials that can be used for chemical reactions, the thin metal layer 34 exposed among the metal wires 36 and the surface layers of the metal wires 36 will be converted into a transparent dielectric layer 38 in the chemical reaction of Step S26, as shown in FIG. 19. After the chemical reaction of Step S26, the thin metal layer 34 and the metal wires 36 form a metal wire grid to form the metal wire-grid polarizer 50 of the present invention. The chemical reaction of Step S26 includes, but is not limited to, oxidation, nitridation, fluorination, or sulfidation.

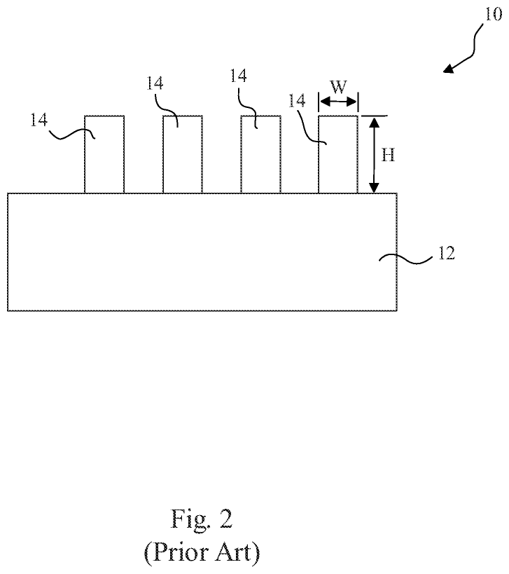

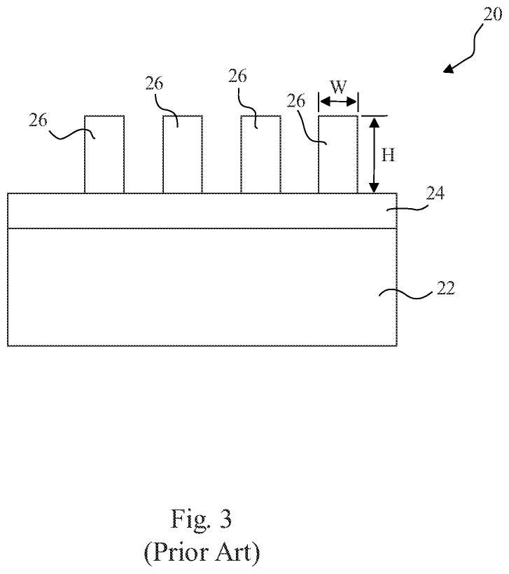

The manufacturing method of the present invention uses an electroforming process to form the metal wires 36. Therefore, the costs of the metal wire-grid polarizers 30 and 50 of the present invention are relatively low and the thin metal layer 34 between the metal wires 36 will be converted into a transparent dielectric layer 38 using a chemical reaction. As a result, the metal wire-grid polarizer of the present invention has good transmittance and extinction ratio. On the other hand, the metal wire grids of the metal wire-grid polarizers 10 and 20 of FIGS. 2 and 3 only include metal wires 14 or 26. The metal wire grid of the metal wire-grid polarizer 30 of FIG. 10 includes a thin metal layer 34 and metal wires 36. Therefore, the height of the metal wire grid of the metal wire-grid polarizer 30 of the present invention will be greater than the height of the metal wire grid of each of the metal wire-grid polarizers 10 and 20. Accordingly, the metal wire-grid polarizer 30 has better transmittance and extinction ratio. In FIGS. 9 and 19, the chemical reaction converts the surface layers of the metal wires 36 into the dielectric layer 38. In general, the thickness of the converted surface layer will not be greater than the thickness of the thin metal layer 34. Therefore, compared with the metal wire grids of the metal wire-grid polarizers 10 and 20 in FIGS. 2 and 3, the metal wire grids of the metal wire-grid polarizers 30 and 50 in FIGS. 9 and 19 have smaller widths and higher heights, thus having better transmittance and extinction ratio.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A method for manufacturing a wire-grid polarizer, comprising:
forming a thin metal layer above a transparent substrate;
performing an electroforming process on the thin metal layer to form metal wires that are arranged in parallel, wherein a part of the thin metal layer is exposed among the metal wires; and
performing a chemical reaction on the part of the thin metal layer to convert the part of the thin metal layer into a transparent dielectric layer, thereby forming the wire-grid polarizer.

2. The method for manufacturing the wire-grid polarizer according to claim 1, wherein the chemical reaction comprises oxidation, nitridation, fluorination, or sulfidation.

3. The method for manufacturing the wire-grid polarizer according to claim 1, wherein surface layers of the metal wires are converted into the dielectric layer using the chemical reaction.

4. The method for manufacturing the wire-grid polarizer according to claim 1, wherein the metal wires and the thin metal layer comprise identical materials.

5. The method for manufacturing the wire-grid polarizer according to claim 1, wherein the metal wires and the thin metal layer comprise different materials.

6. The method for manufacturing the wire-grid polarizer according to claim 1, wherein each of the metal wires comprises multiple layers of different materials.

7. The method for manufacturing the wire-grid polarizer according to claim 1, further comprising forming an optical thin film layer between the thin metal layer and the transparent substrate.
